(19) United States
(12) Patent Application Publication
(10) Pub. No.: US 2003/0029998 A1
(43) Pub. Date: Feb. 13, 2003

(54) Electron beam length measuring instrument and length measuring method

(76) Inventors: Jun Matsumoto, Tokyo (JP); Takayuki Nakamura, Tokyo (JP); Motoji Hirano, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/220,972

(22) PCT Filed: Apr. 24, 2001
(86) PCT No.: PCT/JP01/03533

(30) Foreign Application Priority Data
Apr. 26, 2000 (JP) 2000-125103

(51) Int. Cl. G01N 23/20; G01B 11/02

(52) U.S. Cl. 250/307; 250/306; 356/394

(57) ABSTRACT

An electron beam length-measurement apparatus includes: an electron gun emitting the electron beam; a deflecting unit deflecting the electron beam; a detector operable to detect electrons scattered by the electron beam; a reference-substrate holding unit on which a reference substrate including a reference portion of a reference length it placed; an object holding unit on which the object can be placed; a calibration scanning controller controlling the deflecting unit; a relationship detecting unit detecting a time period of irradiation of the reference portion with the electron beam, and for detecting a relationship between a time period and length of scanning; a length-measurement scanning controller controlling the deflecting unit; and a measurement unit detecting a time period of irradiation of the predetermined portion of the object with the electron beam, and detecting a length corresponding to the detected time period of the irradiation of the object.

This is a continuation application of PCT/JP01/03553 filed on Apr. 24, 2001, further of a Japanese patent application, 2001-125103 filed on Apr. 26, 2000, the contents of which are incorporated herein by reference.

### BACKGROUND OF THE INVENTION

1. Field of the Invention

The present invention relates to an electron beam length-measurement apparatus and a measurement method for measuring a length of a predetermined portion of an object by using an electron beam.

2. Description of the Related Art

An optical length-measurement apparatus has been conventionally known that obtains an image of an object for which a length-measurement is to be performed, such as a GMR (Giant Magneto Resistive) head device, by means of an optical microscope and measures a length of a predetermined portion, for example, a width of a magnetic pole for writing, a width of a reading sensor or the like, based on the obtained image. In recent years, however, a pattern in the GMR head device, such as a magnetic pole pattern, has become finer and therefore the measurement of the length using the optical length-measurement apparatus has become difficult. Thus, an electron beam length-measurement apparatus that performs the length measurement by using an electron beam has attracted attention.

In a case of length measurement by the electron beam length-measurement apparatus, the object of the measurement is scanned with the deflected electron beam. However, as a time period in which the electron beam length-measurement apparatus is used becomes longer, the amount of deflection of the electron beam starts to shift from a predetermined amount. Such a shift of the deflection amount may prevent an accurate length-measurement.

Moreover, even if the electron beam length-measurement apparatuses are used, they cannot detect the length of the same predetermined portion of the same object as the same length. In other words, the length measured by one electron beam length-measurement apparatus may be different from the length measured by another electron beam length-measurement apparatus in many cases.

### SUMMARY OF THE INVENTION

Therefore, it is an object of the present invention to provide an electron beam measurement apparatus and a measurement method, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an electron beam length-measurement apparatus for measuring a length of a predetermined portion of an object to be measured by using an electron beam, comprises: an electron gun operable to emit the electron beam; a deflecting unit operable to deflect the electron beam; a detector operable to detect electrons that are scattered by the electron beam; a reference-substrate holding unit on which a reference substrate including a reference portion is to be placed, the reference portion having a reference length; an object holding unit on which the object to be measured is to be placed; a calibration scanning controller operable to control the deflecting unit to scan a predetermined position including the reference portion on the reference substrate with the electron beam; a relationship detecting unit operable to detect a time period in which the reference portion of the reference substrate is irradiated with the electron beam based on a changing manner of the electrons successively detected by the detector during scanning of the reference substrate with the electron beam, and to detect a relationship between a time period and a length of scanning of the electron beam based on the time period detected by the relationship detecting unit and the reference length; a length-measurement scanning controller operable to control the deflecting unit to scan the object with the electron beam; and a measurement unit operable to detect a time period in which the predetermined portion of the object is irradiated with the electron beam based on a changing manner of the electrons successively detected by the detector during scanning of the object with the electron beam, and to detect a length corresponding to the time period detected by the measurement unit based on the relationship detected by the relationship detecting unit.

The calibration scanning controller may control the deflecting unit to scan the predetermined position including the reference portion on the reference substrate with the electron beam over a plurality of deflection lengths. In this case, the relationship detecting unit detects the relationship for each of the deflection lengths, the length-measurement scanning controller controls the deflecting unit to scan the object with the electron beam over one of the deflection lengths, and the measurement unit detects the length corresponding to the time period detected by the measurement unit based on the relationship detected by the relationship detecting unit for the one of the deflection lengths.

The calibration scanning controller may control the deflecting unit to further scan another position including the reference portion that is different from the predetermined position on the reference substrate with the electron beam after a predetermined time, and the relationship detecting unit detects the time period in which the reference portion of another position on the reference substrate is irradiated with the electron beam based on a changing manner of the electrons successively detected by the detector during scanning of another position is irradiated with the electron beam, and detects the relationship between the time period and length of scanning based on the time period detected by the relationship detecting unit and the reference length.

The other position of the reference substrate for the calibration scanning controller is placed at a position obtained by moving the irradiation position of the electron beams perpendicular to a direction of the scanning with the electron beam on the predetermined position of the reference substrate.

The reference-substrate holding unit may hold the reference substrate in such a manner that the reference substrate is attachable and removable.

The reference substrate may include a plurality of reference portions having the same reference length.

The plurality of reference portions on the reference substrate may be arranged on a line, the calibration scanning controller may control the deflecting unit to scan a predetermined position including the reference portions with the electron beam along the line, and the relationship detecting unit may detect a plurality of time periods in which the reference portions are irradiated with the electron beam, respectively, and detects the relationship between the time period and length of scanning based on the plurality of time periods and the reference length of the reference portions.

The reference substrate may include a plurality of reference portions having different reference lengths.

The reference portions on the reference substrate may be arranged on a line, the calibration scanning controller may control the deflecting unit to scan a predetermined position including the reference portions with the electron beam along the line, and the relationship detecting unit may detect a plurality of time periods in which the reference portions are irradiated with the electronbeam, respectively, and detects the relationship between a plurality of time periods and lengths of scanning with the electron beam based on the plurality of time periods and the reference lengths of the reference portions.

The reference substrate may be a substrate fabricated based on a standard substrate showing a standard length or a substrate for which a reference length of a reference portion has been measured by using the standard reference as a reference.

According to the second aspect of the present invention, a method for measuring a length of a predetermined portion of an object to be measured by using an electron beam, comprises: a calibration scanning step for scanning a predetermined position of a reference substrate having a reference portion having a reference length with the electron beam, the predetermined position including the reference portion; relationship detecting step for detecting a time period in which the reference portion of the reference substrate is irradiated with the electron beam based on a changing manner of electrons successively detected when the reference substrate is scanned with the electron beam, and for detecting a relationship between a time period and a length of scanning with the electron beam based on the detected time period and the reference length of the reference portion; a measurement scanning step for scanning the object with the electron beam; a measurement step for detecting a time period in which the predetermined portion of the object is irradiated with the electron beam based on the changing manner of the electrons successively detected when the object is scanned with the electron beam, and for detecting a length corresponding to the time period detected in the measurement step based on the relationship detected in the relationship detecting step detecting; a re-calibration scanning step for scanning another position on the reference substrate that is different from the predetermined position with the electron beam after a predetermined time, the another position including the reference portion; and a relationship re-detecting step for detecting a time period in which the reference portion of another position on the reference substrate is irradiated with the electron beam based on the changing manner of the electrons successively detected when another position is scanned with the electron beam and for re-detecting the relationship between the time period and length of scanning with the electron beam based on the time period detected in the relationship re-detecting step and the reference length of the reference portion.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a structure of an electron beam length-measurement apparatus according to an embodiment of the present invention.

FIGS. 2A and 2B show a structure of a stage and a structure of a reference substrate, respectively.

FIG. 3 is a flowchart showing operations of the electron beam length-measurement apparatus according to the embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

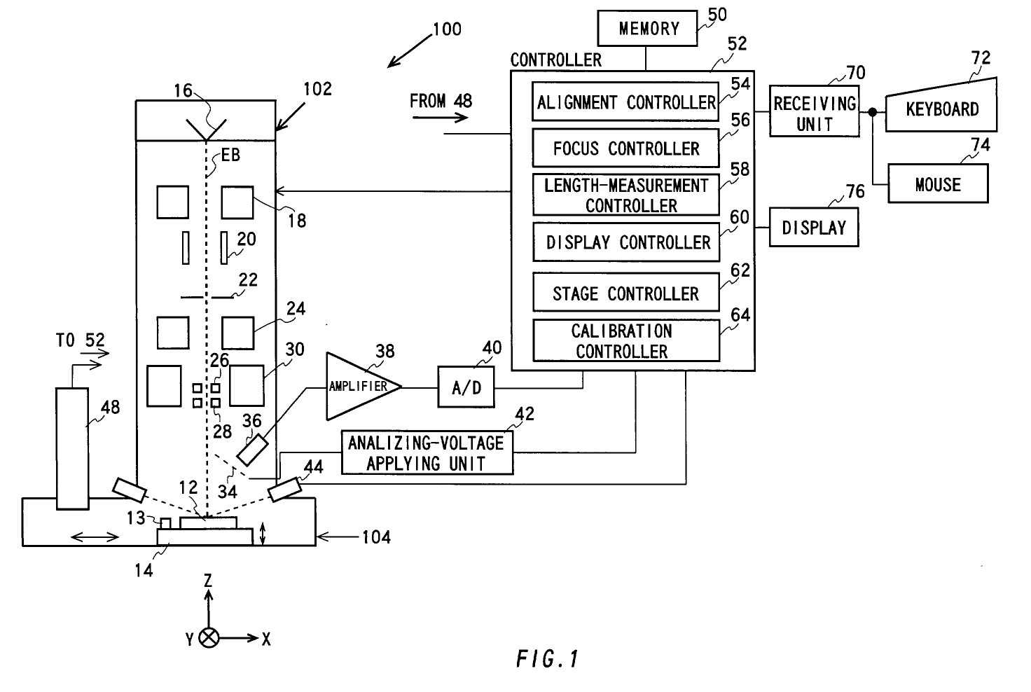

FIG. 1 schematically shows a structure of an electron beam length-measurement apparatus according to an embodiment of the present invention. In the following description, X-, Y- and Z-axes are defined as shown in FIG. 1.

The electron beam length-measurement apparatus of the present embodiment is an electron beam length-measurement apparatus that can measure a length of a predetermined portion of a GMR head device that is an example of an object for which a length measurement is performed.

The object 12 may be a semiconductor device including active devices such as ICs (Integrated Circuits) or LSIs (Large-Scale Integrated Circuits) or other devices such as a passive device or various types of sensors. Also, the object may be a device in which the above-mentioned devices are housed in a single package or a device such as a breadboard having a predetermined function by being provided with the above-mentioned devices mounted on a printed board. Moreover, the object may be a device that could be damaged by a magnetic field, such as the GMR head device.

The electronbeam length-measurement apparatus 100 includes an electronbeam lens barrel 102, a vacuum chamber 104, an amplifier 38, an analog-to-digital converter (A/D converter) 40, a memory 50, a controller 52, an analyzing-voltage applying unit 42, a receiving unit 70, a keyboard 72, a mouse 74 and a display 76. The electron beam lens barrel 102 includes an electron gun 16, an electron lens 18, a shaping aperture 22, an electron lens 24, a deflector 26 as an exemplary deflecting unit, an astigmatism correcting lens 28, an objective lens 30, an energy filter 34, and a detector 36. Each of the electron lens 18, the electron lens 24, the deflector 26, the astigmatism correcting lens 28 and the objective lens 30 can use the magnetic field or electric field. In the present embodiment, it is preferable that these elements use the electric field since the object to be measured is the device that may be damaged by the magnetic field, such as the GMR device.

The vacuum chamber 104 includes a height detecting unit 44, a stage 14 as an exemplary reference-substrate holding unit and an exemplary object holding unit, and an optical microscope 48. The height detecting unit 44 detects the height of the object 12 placed on the stage 14 in the Z-axis direction. In the present embodiment, the height detecting unit 44 irradiates the object 12 to be measured placed on the stage 14 with laser light and receives the laser light reflected from the object 12 to be measured, thereby detecting the height of the object 12 in the Z-axis direction based on the received laser light. The height detecting unit 44 inputs the detected Z-axis height of the object 12 into the controller 52.

The stage 14 holds a reference substrate 13 in such a manner that the reference substrate 13 is attachable and removable. On the reference substrate 13, a reference pattern is formed that has a reference portion of a reference length that is used as a reference for the length measurement in the electron beam length-measurement apparatus. The stage 14 also holds the object 12 to be measured in such a manner that the object 12 is attachable and removable. The stage 14 is arranged to be movable in the vacuum chamber 104 in directions along the X-, Y- and Z-axes. The optical microscope 48 captures an image in a field of view thereof and inputs the captured image to the controller 52. In the present embodiment, the optical microscope 48 captures an image of the object 12 placed on the stage 14, located in the field of view when the global alignment is performed, and inputs the captured image to the controller 52.

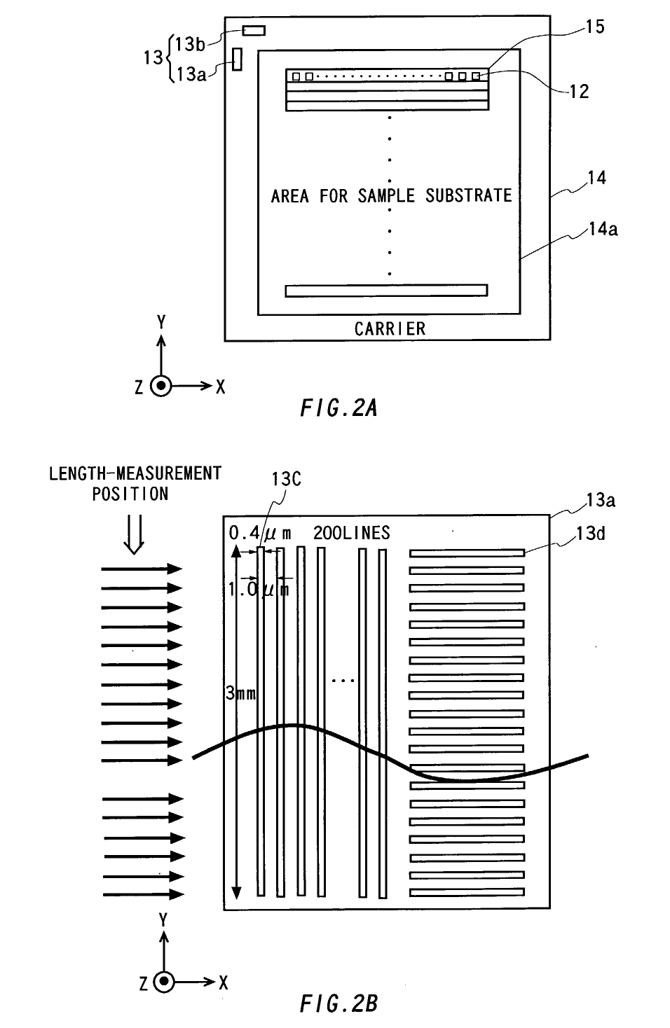

FIGS. 2A and 2B show a structure of a surrounding area of the stage 14 and a structure of the reference substrate 13 according to an embodiment of the present invention. The stage 14 has a carrier 14a for holding the object 12 thereon, as shown in FIG. 2A. In the present embodiment, the carrier 14a can hold a plurality of sample substrates 15 each having a plurality of objects 12 to be measured in an area of the sample substrate thereof. Please note that the sample substrate 15 is a so-called bar sliced from a wafer on which a plurality of objects to be measured are formed.

The stage 14 also includes a reference substrate 13a for a length calibration in the X-axis direction and a reference substrate 13b for a length calibration in the Y-axis direction. The reference substrate 13a has a plurality of (200 in FIG. 2B) convex portions 13c having a length in the X-axis direction of 0.4 μm and a length in the Y-axis direction of 3 mm that are arranged in the X-axis direction. The reference substrate 13a also has a plurality of convex portions 13d having a length in the X-axis direction that is longer than a length in the Y-axis direction, that are arranged in the Y-axis direction. In the reference substrate 13a, a region including each convexportion 13c, a region including each convex portion 13c and an area from that convex portion 13c to the next convex portion 13c, a region including a plurality of convex portions 13c or the like, is set as the reference portion, for example. In a case of the calibration in the X-axis direction using the reference substrate 13a, scanning with the electron beam is performed parallel to the X-axis. The convex portions 13d are used for detecting a position on the Y-axis direction in the reference substrate 13a.

The reference substrate 13b for the length calibration in the Y-axis direction has the same structure as that of the reference substrate 13a shown in FIG. 2B, and is placed on the stage 14 to have the same orientation of the reference substrate 13a when the reference substrate 13a shown in FIG. 2B is rotated in a counterclockwise direction by 90 degrees. In the present embodiment, the reference substrates 13 are fabricated based on a standard substrate that shows a standard length.

In the electron beam measurement apparatus shown in FIG. 1, an electron beam EB is emitted from the electron gun 16. The electron beam EB is then subjected to a predetermined adjustment by the electron lens 18 and is shaped to have a predetermined shape by the opening of the shaping aperture 22.

The deflector 26 deflects the shaped electron beam EB to change a position where the electron beam reaches. The astigmatism correcting lens 28 corrects astigmatism occurring in the electron beam EB. Secondary electrons generated by irradiation of the object 12 or the reference substrate 13 with the electron beam are successively detected by the detector 36 via the energy filer 34. The detector 36 inputs the detected amount of secondary electrons to the amplifier 38.

The amplifier 38 inputs the amount of secondary electrons to the A/D converter 40 after amplifying it. The A/D converter 40 converts the secondary electron amount input from the amplifier 38 into a digital signal, and inputs the digital signal to the controller 52. The analyzing-voltage applying unit 42 applies an analyzing voltage to the energy filter 34 in accordance with a control by the controller 52. The memory 50 stores a relationship between a time period and length of scanning with the electron beam, for example, at least one factor used in calculation for obtaining the length from the scanning time period. In the present embodiment, a ratio of a unit length to a deflection length of the electron beam, that is, a magnifying power is adjusted by adjusting the deflection length of the electron beam as described later. The adjustment of the magnifying power may cause a change of the length over which scanning with the electron beam is performed in a unit time period. Thus, the memory 50 stores the relationship between the time period and the length of the electron beam scanning so as to correspond to the respective magnifying powers. The receiving unit 70 receives a user's instruction from the keyboard 72 or the mouse 74. In the present embodiment, the receiving unit 70 receives an instruction from the user for calibration of the length measurement.

The controller 52 includes an alignment controller 54, a focus controller 56, a length-measurement controller 58 as an example of a length-measurement scanning controller and a measurement unit, a display controller 60, a stage controller 62 and a calibration controller 64 as an exemplary calibration scanning controller and an exemplary relationship detecting unit. The alignment controller 54 performs an adjustment, that is the global alignment, in such a manner that the object 12 to be measured can be moved to a position in a region that can be irradiated with the electron beam from the electron gun 16 based on the image input from the optical microscope 48.

After the global alignment, the alignment controller 54 makes the stage controller 62 move the object 12 to the position in the region that can be irradiated with the electron beam, and then performs a local alignment. In other words, the alignment controller 54 causes scanning of the object 12 with the electron beam to form a secondary electron image of the object 12 based on the manner in which the secondary electron amount detected by the detector 36 is changed. Then, the alignment controller 54 detects displacement amounts in the X-axis direction and the Y-axis direction with respect to predetermined references, the rotation amount and the like, based on the secondary electron image and performs various types of adjustment based on the detected amounts. In the present embodiment, the alignment controller 54 adjusts the position and direction of scanning with the electron beam by the deflector 26.

The focus controller 56 makes the stage controller 62 adjust the height of the object 12 in the Z-axis direction based on the height of the object 12 in the Z-axis direction input from the height detector 44 in such a manner that the object 12 to be measured is brought into the focus of the objective lens 30. The length-measurement controller 58 adjusts the intensity of the magnetic field generated by the objective lens 30, thereby changing the length of the deflection of the electron beam by the deflector 26. Thus, the ratio of the unit length in a length-measurement deflection range, that is the magnifying power, is adjusted. The length-measurement controller 58 controls the deflector 26 to scan the object 12 with the electron beam over a predetermined deflection length while the magnifying power is adjusted to a predetermined magnifying power, and detects a time period in which a predetermined portion of the object 12 is irradiated for which the length measurement is to be performed with the electron beam based on the manner in which the secondary electron amount successively detected by the detector 36 is changed. Then, the length-measurement controller 58 detects a length corresponding to the detected period based on the relationship corresponding to the predetermined magnifying power that is stored in the memory 50.

The display controller 60 controls the display 76 to display a length of the predetermined portion of the object 12 that has been detected by the length-measurement controller 58. The stage controller 62 moves the stage 14 in the X-Y plane. For example, the stage controller 62 moves the stage 14 so that the object 12 to be measured placed on the stage 14 is located within the field of view of the optical microscope 48. The stage controller 62 moves the stage 14 in such a manner that the object 12 to be measured is positioned substantially at the center of the optical axis of the electron beam. The stage controller 62 also moves the stage 14 so as to locate the reference substrate 13 placed on the stage 14 at a position that can be irradiated with the electron beam. Moreover, the stage controller 62 moves the stage 14 in the Z-axis direction.

The calibration controller 64 changes the length of the deflection of the electron beam by the deflector 26 by adjusting the intensity of the magnetic field generated by the objective lens 30, thereby adjusting the unit length to the deflection length, that is, the magnifying power. The calibration controller 64 also controls the detector 26 to scan a predetermined position on the reference substrate 13, which includes the reference portion, with the electron beam with a plurality of magnifying powers, and detects the time period in which the reference portion is irradiated with the electron beam based on the changing manner of the secondary electrons successively detected by the detector 36. In the present embodiment, the calibration controller 64 controls the deflector 26 to scan the reference substrate 13a for the X-axis calibration with the electron beam along the X-axis direction, and to scan the reference substrate 13b for the Y-axis calibration with the electron beam along the Y-axis direction.

The calibration controller 64 detects the relationship between the time period and the length of scanning for each of the magnifying powers based on the detected time period in which the reference portion is irradiated with the electron beam and the length of the reference portion, and stores the detected relationship in the memory 50. In the present embodiment, a plurality of reference portions having the same length are arranged in the direction along which the substrate 13a or 13b is scanned with the electron beam. Thus, the relationship may be detected by obtaining an average of the time periods in each of which the reference portion is irradiated with the electron beam. In this case, the relationship between the time period and the length of scanning can be detected with high accuracy.

Moreover, since a plurality of reference portions having different lengths are arranged in the direction along which the substrate 13a or 13b is scanned with the electron beam, the relationship between the time period in which each reference portion is irradiated with the electron beam and the length of that reference portion may be detected. In this case, a plurality of lengths and the time periods respectively corresponding thereto of scanning can be detected appropriately.

The calibration controller 64 further performs scanning with the electron beam at another position including the reference portion, that is different from the predetermined position on the reference substrate 13, by the deflector 26 after a predetermined time, and detects the time period in which the reference portion of the other position is irradiated with the electron beam based on the changing manner of the secondary electrons successively detected by the detector 36. In the present embodiment, the other position including the reference portion different from the predetermined position on the reference substrate 13 is a position obtained by moving the irradiation position of the electron beam in the Y-axis direction in a case of the reference substrate 13a for the length calibration in the X-axis direction. When the reference substrate 13 is irradiated with the electron beam, an irradiated portion may be damaged. However, since scanning with the electron beam is performed for the other position including the reference portion after the predetermined time as described above, it is possible to obtain the relationship between the time period and the length with high accuracy based on the reference portion that has not been damaged by the electron beam.

The calibration controller 64 detects the relationship between the time period and the length of the scanning based on the period of the irradiation of the other position and the length of the reference portion, and updates the relationship stored in the memory 50. In the above description, the time after which scanning of the other position with the electron beam is performed may be a time at which an instruction of the calibration is received from the user, or a time at which scanning of the same position on the reference substrate 13 with the electron beam has been performed a predetermined number of times or more.

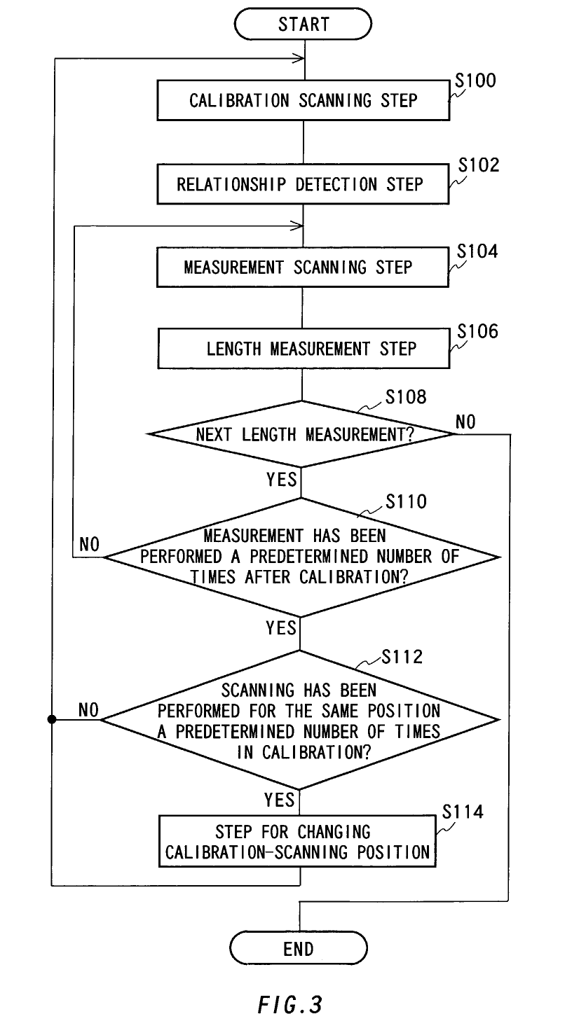

FIG. 3 is a flowchart for explaining the operation of the electron beam length-measurement apparatus according to the present embodiment. In the electron beam length-measurement apparatus, the stage controller 62 moves the stage 14 so as to locate the reference substrate 13 placed on the stage 14 at a position that can be irradiated with the electron beam. Then, the calibration controller 64 controls the deflector 26 to scan the predetermined position including the reference portion on the reference substrate 13 with the electron beam with each of a plurality of magnifying powers (Step S100). The calibration controller 64 also detects the time period in which the reference portion is irradiated with the electron beam based on the changing manner of the secondary electrons successively detected by the detector 36, and detects the relationship between the time period and length of scanning for every magnifying power based on the detected time period and the length of the reference portion. The detected relationship is stored in the memory 50 so as to correspond to the magnifying power (Step S102).

After the object 12 to be measured is placed on the stage 14, the alignment controller 54 performs the global alignment and the local alignment. Then, the length-measurement controller 58 controls the deflector 26 to scan the object 12 with the electron beam while adjusting the magnifying power to a predetermined magnifying power (Step S104). Also, the length-measurement controller 58 detects the time period in which the predetermined portion of the object 12 is irradiated with the electron beam based on the changing manner of the secondary electrons successively detected by the detector 36, and then detects the length corresponding to the detected time period based on the relationship for the currently set magnifying power stored in the memory 50 (Step S106).

Then, it is detected whether or not there is a next object 12 for which the measurement is to be performed (Step S108). In a case where no object 12 to be measured remains, the operation is finished. In another case where another object 12 remains, it is further detected whether or not the number of times of the length measurement for the current object 12 after the relationship was detected exceeds a predetermined number (Step S110). When the number of times of the length measurement performed for the current object 12 after the relationship was detected does not exceed the predetermined number, there is a strong possibility that the detected relationship appropriately represents the actual relationship between the time period and length of scanning in the electron beam length-measurement apparatus. Thus, the length-measurement operation (the operation from Steps S104, S106, S108 and S110) for the next object 12 is performed.

On the other hand, when the number of times of the length measurement performed for the current object 12 after the relationship was detected exceeds the predetermined number, it is likely that the detected relationship is different from the actual relationship between the time period and length of scanning in the electron beam length-measurement apparatus. Thus, it is further detected whether or not the same position on the reference substrate 13 has been scanned more than a predetermined number of times for detecting the relationship (Step S112).

In a case where the same position on the reference substrate 13 has not been scanned the plurality of number of times or more, there is a weak possibility that the reference portion of that position on the reference substrate 13 is damaged. Therefore, scanning with the electron beam is performed for that position so as to detect the relationship for every magnifying power, thereby updating the relationship in the memory 50 (Steps S100 and S102). On the other hand, in another case where the same position of the reference substrate 13 has been scanned more than a predetermined number of times, there is a strong possibility that the reference portion included in that position is damaged. Therefore, the calibration controller 64 controls the deflector 26 to change the position for which scanning with the electron beam is performed (Step S112), and detects the relationship for every magnifying power by scanning the new position with the electron beam, thereby updating the relationship stored in the memory 50 (Steps S100 and S102). After the update of the stored relationship, the length measurement for the object 12 is performed in the above-described manner (Steps S104 and S106).

As described above, according to the electron beam length-measurement apparatus of the present embodiment, it is possible to detect the relationship between the time period and length of scanning with high accuracy by using the reference substrate. Moreover, since the electron beam length-measurement apparatus can hold the reference substrate therein, it is possible to easily calibrate the relationship between the time period and length of scanning at a desired time. In addition, the reference substrate 13 is fabricated based on a standard substrate. Thus, the electron beam length-measurement apparatuses according to the present embodiment can obtain the same length by measurement for the same portion, as long as these electron beam length-measurement apparatuses use the relationship calibrated by using the reference substrates 13 fabricated by the same standard substrate for the detection of the length.

The present invention cannot be limited to the above embodiments but can be modified in various ways. For example, the position and direction of scanning with the electron beam are adjusted in the local alignment for realizing the appropriate scanning of the object to be measured with the electron beam in the above embodiment. However, the adjustment may be performed by moving the stage 14. Moreover, although the object 12 is brought into the focus of the objective lens by moving the stage 14 to adjust the position in the Z-axis direction, the present invention is not limited thereto. For example, the focusing may be performed by adjusting the position of the focus of the lens.

In the above embodiment, the secondary electrons generated by the irradiation of the object 12 or the reference substrate 13 with the electron beam are detected by the detector 36, and based on the secondary electron amount the relationship between the time period and length of scanning is detected. However, the present invention is not limited thereto. For example, the detector 36 may detect backscattered electrons scattered by the object 12 or the reference substrate 13 and based on the backscattered electron amount the relationship between the time period and length of scanning may be detected.

In the above embodiment, the relationship stored in the memory 50 is updated when the length measurement has been performed a predetermined number of times. However, the present invention is not limited thereto. The stored relationship in the memory 50 may be updated when a predetermined time period has passed. Moreover, a temperature sensor may be provided in the electron beam lens barrel 102 to detect the temperature in the electron beam lens barrel 102, and the stored relationship may be updated in a case where the temperature detected by the temperature sensor is shifted from a temperature at which the previous update of the relationship is performed by predetermined temperatures.

In the above embodiment, although the reference substrate 13 fabricated based on the standard substrate showing the standard length is used, the present invention is not limited thereto. For example, a traced reference substrate, that has a reference portion for which the length was measured by using the standard substrate (a primary standard substrate) as a reference can be used.

As is apparent from the above, according to the present invention, it is possible to measure a length of a predetermined portion of an object to be measured with high accuracy.

Although the present invention has been described by way of exemplary embodiments, it should be understood that those skilled in the art might make many changes and substitutions without departing from the spirit and the scope of the present invention which is defined only by the appended claims.

What is claimed is:

1. An electron beam length-measurement apparatus for measuring a length of a predetermined portion of an object to be measured by using an electron beam, comprising:
an electron gun operable to emit said electron beam;
a deflecting unit operable to deflect said electron beam;
a detector operable to detect electrons that are scattered by said electron beam;
a reference-substrate holding unit on which a reference substrate including a reference portion is to be placed, said reference portion having a reference length;
an object holding unit on which said object to be measured is to be placed;
a calibration scanning controller operable to control said deflecting unit to scan a predetermined position including said reference portion on said reference substrate with said electron beam;
a relationship detecting unit operable to detect a time period in which said reference portion of said reference substrate is irradiated with said electron beam based on a changing manner of said electrons successively detected by said detector during said scanning of said reference substrate with said electron beam, and to detect a relationship between a time period and a length of the scanning of said electron beam based on said time period detected by said relationship detecting unit and said reference length;
a length-measurement scanning controller operable to control said deflecting unit to scan said object with said electron beam; and
a measurement unit operable to detect a time period in which said predetermined portion of said object is irradiated with said electron beam based on a changing manner of said electrons successively detected by said detector during said scanning of said object with said electron beam, and to detect a length corresponding to said time period detected by said measurement unit based on said relationship detected by the relationship detecting unit.

2. An electron beam length-measurement apparatus as claimed in claim 1, wherein said calibration scanning controller controls said deflecting unit to scan said predetermined position including said reference portion on said reference substrate with said electron beam over a plurality of deflection lengths,
said relationship detecting unit detects said relationship for each of said deflection lengths,
said length-measurement scanning controller controls said deflecting unit to scan said object with said electron beam over one of said deflection lengths, and
said measurement unit detects said length corresponding to said time period detected by said measurement unit based on said relationship detected by said relationship detecting unit for said one of said deflection lengths.

3. An electron beam length-measurement apparatus as claimed in claim 1, wherein said calibration scanning controller controls said deflecting unit to further scan another position including said reference portion that is different from said predetermined position on said reference substrate with said electron beam after a predetermined time, and
said relationship detecting unit further detects said time period in which said reference portion of said another position on said reference substrate is irradiated with said electron beam based on a changing manner of said electrons successively detected by said detector during said scanning of said another position is irradiated with said electron beam, and detects said relationship between said time period and length of scanning based on said time period detected by said relationship detecting unit and said reference length.

4. An electron beam length-measurement apparatus as claimed in claim 1, wherein said reference-substrate holding unit holds said reference substrate in such a manner that said reference substrate is attachable and removable.

5. An electron beam length-measurement apparatus as claimed in claim 1, wherein said reference substrate includes a plurality of reference portions having the same reference length.

6. An electron beam length-measurement apparatus as claimed in claim 5, wherein said plurality of reference portions on said reference substrate are arranged on a line,
said calibration scanning controller controls said deflecting unit to scan a predetermined position including said reference portions with said electron beam along said line, and
said relationship detecting unit detects a plurality of time periods in which said reference portions are irradiated with said electron beam, respectively, and detects said relationship between said time period and length of said scanning based on said plurality of time periods and said reference length of said reference portions.

7. An electron beam length-measurement apparatus as claimed in claim 1, wherein said reference substrate includes a plurality of reference portions having different reference lengths.

8. An electron beam length-measurement apparatus as claimed in claim 7, wherein said reference portions on said reference substrate are arranged on a line,
said calibration scanning controller controls said deflecting unit to scan a predetermined position including said reference portions with said electron beam along said line, and
said relationship detecting unit detects a plurality of time periods in which said reference portions are irradiated with said electron beam, respectively, and detects said relationship between a plurality of time periods and lengths of said scanning with said electron beam based on said plurality of time periods and said reference lengths of said reference portions.

9. An electron beam length-measurement apparatus as claimed in claim 1, wherein said reference substrate is a substrate fabricated based on a standard substrate showing a standard length or a substrate for which a reference length of a reference portion has been measured by using said standard reference as a reference.

10. A method for measuring a length of a predetermined portion of an object to be measured by using an electron beam, comprising:
calibration scanning step for scanning a predetermined position of a reference substrate having a reference portion having a reference length with said electron beam, said predetermined position including said reference portion;
relationship detecting step for detecting a time period in which said reference portion of said reference substrate is irradiated with said electron beam based on a changing manner of electrons successively detected when said reference substrate is scanned with said electron beam, and for detecting a relationship between a time period and a length of scanning with said electron beam based on said detected time period and said reference length of said reference portion;
measurement scanning step for scanning said object with said electron beam;
measurement step for detecting a time period in which said predetermined portion of said object is irradiated with said electron beam based on said changing manner of said electrons successively detected when said object is scanned with said electron beam, and for detecting a length corresponding to said time period detected in said measurement step based on said relationship detected in said relationship detecting step detecting;
re-calibration scanning step for scanning another position on said reference substrate that is different from said predetermined position with said electron beam after a predetermined time, said another position including said reference portion; and
relationship re-detecting step for detecting a time period in which said reference portion of said another position on said reference substrate is irradiated with said electron beam based on said changing manner of said electrons successively detected when said another position is scanned with said electron beam and for re-detecting said relationship between said time period and length of scanning with said electron beam based on said time period detected in said relationship re-detecting step and said reference length of said reference portion.

11. An electron beam length-measurement apparatus as claimed in claim 3, wherein said another position of said reference substrate for said calibration scanning controller is placed at a position obtained by moving the irradiation position of the electron beams perpendicular to a direction of the scanning with the electron beam on said predetermined position of said reference substrate.
